(19) United States
(12) Patent Application Publication
(10) Pub. No.: US 2014/0271287 A1
(43) Pub. Date: Sep. 18, 2014

(54) MOTOR

(71) Applicant: SAMSUNG ELECTRO-MECHANICS CO., LTD., Suwon (KR)

(72) Inventor: Viatcheslav SMIRNOV, Suwon (KR)

(21) Appl. No.: 13/913,354

(22) Filed: Jun. 7, 2013

(30) Foreign Application Priority Data
Mar. 15, 2013 (KR) 10-2013-0028274

(51) Int. Cl. F04D 29/041; F16C 32/06; F16F 15/14

(52) U.S. Cl. CPC F04D 29/0413; F16F 15/14; F16C 32/0633
USPC 417/423.7; 74/572.2; 384/112; 384/120

(57) ABSTRACT

There is provided a motor including: an upper housing; a lower housing coupled to the upper housing to provide an internal space; a shaft disposed within the internal space and coupled to a hydrodynamic bearing assembly; a rotor core coupled to the shaft and rotated together with the shaft; and a balancing unit coupled to the shaft to correct a rotational imbalance at the time of rotation of the shaft and the rotor core.

### CROSS-REFERENCE TO RELATED APPLICATIONS

This application claims the priority of Korean Patent Application No. 10-2013-0028274 filed on Mar. 15, 2013, in the Korean Intellectual Property Office, the disclosure of which is incorporated herein by reference.

### BACKGROUND OF THE INVENTION

1. Field of the Invention

The present invention relates to a motor.

2. Description of the Related Art

A vacuum cleaner includes a motor creating a vacuum state in an interior portion thereof. In a general motor for a vacuum cleaner, ball bearings have been used. However, in the case of using ball bearings, noise or vibrations generated at the time of high speed rotation may have a negative effect on motor performance, and resistance to external impacts, or the like, may be low.

In addition, in the case of using ball bearings, when a rotor is rotated at high speed, abrasion is generated due to friction, such that motor performance may be deteriorated in a relatively short time.

Further, in the case of using a hydrodynamic bearing in the motor for a vacuum cleaner, a problem in which a rotating member is rotated in an eccentric manner in which it is off-set from the center of a rotational axis due to mass unbalance therein may occur.

### SUMMARY OF THE INVENTION

An aspect of the present invention provides a motor capable of having an increased lifespan, suppressing the generation of noise or vibrations at the time of high speed rotation, enhancing resistance to external impacts, or the like, preventing the leakage of lubricating fluid and the introduction of external foreign objects, and correcting a rotational imbalance at the time of rotation of a rotating member.

According to an aspect of the present invention, there is provided a motor including: an upper housing; a lower housing coupled to the upper housing to provide an internal space; a shaft disposed within the internal space and coupled to a hydrodynamic bearing assembly; a rotor core coupled to the shaft and rotated together with the shaft; and a balancing unit coupled to the shaft to correct a rotational imbalance at the time of rotation of the shaft and the rotor core.

The balancing unit may be spaced apart from the rotor core by a predetermined interval.

The balancing unit may include a groove formed in an outer peripheral surface thereof.

The motor may further include: a stator coupled to the lower housing and disposed to have a micro clearance with regard to the rotor core; an impeller fixed to an upper portion of the shaft; and an impeller housing coupled to the upper housing.

The hydrodynamic bearing assembly may include: a fixed part having a central hole into which the shaft is inserted and rotatably supporting the shaft; an upper sealing part coupled to an upper portion of the shaft and disposed to form a micro clearance with regard to an upper portion of the fixed part; and a lower sealing part coupled to a lower portion of the shaft and disposed to form a micro clearance with regard to a lower portion of the fixed part.

The motor may further include a labyrinth sealing member coupled to the lower portion of the fixed part to form a labyrinth seal between the labyrinth sealing member and the lower sealing member.

At least one facing surface of the lower sealing part and the labyrinth sealing member may be provided with a groove.

The balancing unit may be disposed above the fixed part, and the rotor core may be disposed below the fixed part.

The upper and lower portions of the fixed part may be provided with first and second groove parts depressed inwardly, respectively, and end portions of the upper sealing part and the lower sealing part may be accommodated in the first and second groove parts, respectively.

At least a portion of an inner wall of the fixed part forming the first and second groove parts may be tapered.

The upper sealing part and the first groove part may have a first liquid-vapor interface formed therebetween, and the lower sealing part and the second groove part may have a second liquid-vapor interface formed therebetween.

The fixed part may be provided with a first bypass channel so that upper and lower surfaces of the fixed part are in communication with each other.

The fixed part may be provided with a second bypass channel so that a clearance between the shaft and the fixed part and the first bypass channel are in communication with each other.

According to another aspect of the present invention, there is provided a motor including: an upper housing; a lower housing coupled to the upper housing to provide an internal space; a shaft disposed within the internal space and coupled to a hydrodynamic bearing assembly; a rotor core coupled to the shaft and rotated together with the shaft; and a balancing unit coupled to the shaft to correct a rotational imbalance at the time of rotation of the shaft and the rotor core, wherein the hydrodynamic bearing assembly includes: a fixed part having a central hole into which the shaft is inserted and rotatably supporting the shaft; an upper sealing part coupled to an upper portion of the shaft and disposed to form a micro clearance with regard to an upper portion of the fixed part; and a lower sealing part coupled to a lower portion of the shaft and disposed to form a micro clearance with regard to a lower portion of the fixed part, the fixed part being provided with a separation groove depressed from an inner peripheral surface of the fixed part to separate a lubricating fluid provided in a clearance between the shaft and the fixed part into upper and lower portions in an axial direction and being provided with a communications part allowing the separation groove to be in communication with the outside.

The motor may further include: a stator coupled to the lower housing and disposed to have a micro clearance with regard to the rotor core; an impeller fixed to the upper portion of the shaft; and an impeller housing coupled to the upper housing.

The upper sealing part and the fixed part may have a first liquid-vapor interface formed therebetween, and the lower sealing part and the fixed part may have a second liquid-vapor interface formed therebetween.

The separation groove may have a third liquid-vapor interface formed in an upper portion thereof in the axial direction and a fourth liquid-vapor interface formed in a lower portion thereof in the axial direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a motor according to an embodiment of the present invention;

FIG. 2 is a cross-sectional view showing a state in which a shaft and a hydrodynamic bearing assembly are coupled to each other in the motor according to the embodiment of the present invention;

FIGS. 3A and 3B are enlarged cross-sectional views of part A of FIG. 2;

FIG. 4 is a cross-sectional view showing an oil storage part included in the hydrodynamic bearing assembly of the motor according to the embodiment of the present invention;

FIGS. 5A through 6B are cross-sectional views showing a bypass channel included in the hydrodynamic bearing assembly of the motor according to the embodiment of the present invention;

FIG. 7 is a cross-sectional view showing a state in which the shaft, the hydrodynamic bearing assembly, an impeller, and a balancing unit are coupled to one another in the motor according to the embodiment of the present invention; and

FIG. 8 is a cross-sectional view showing a state in which a shaft and a hydrodynamic bearing assembly are coupled to each other in a motor according to another embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

FIG. 1 is a schematic cross-sectional view of a motor according to an embodiment of the present invention.

Referring to FIG. 1, the motor according to the embodiment of the present invention may include a hydrodynamic bearing assembly 100, an upper housing 400, a lower housing 500, a rotor 200, a stator 300, a balancing unit 150, an impeller 600, and an impeller housing 700.

Terms with respect to directions will be first defined. As viewed in FIG. 1, an axial direction refers to a vertical direction based on a shaft 210, and an outer radial or inner radial direction refers to a direction towards an outer edge of a fixed part 110 based on the shaft 210 or a direction towards the center of the shaft 210 based on the outer edge of the fixed part 110.

The hydrodynamic bearing assembly 100 may include the shaft 210, the fixed part 110, an upper sealing part 120, and a lower sealing part 130.

The shaft 210 may be inserted into a central hole of the fixed part 110, and the fixed part 110 may support the shaft 210 so that the shaft 210 is rotatable.

Here, the shaft 210 may be inserted into the fixed part 110 so that a micro clearance is formed between an outer peripheral surface of the shaft 210 and an inner peripheral surface of the fixed part 110, whereby the micro clearance may be provided with a lubricating fluid.

An action and an effect of the hydrodynamic bearing assembly 100 will be described in detail with reference to FIGS. 2 through 4.

The stator 300 may include a stator core 310 having a plurality of salient poles, an insulator 320 formed of an insulating member and coupled to the stator core 310, and a stator coil 330 wound around a circumferential surface of the stator core 310.

The rotor 200 may include a rotor core 220 disposed to be rotatable with respect to the stator 300 and having a plurality of salient poles protruded in a radial direction and the shaft 210 coupled to the rotor core 220 and rotated together with the rotor core 220.

That is, the rotor 200 may be disposed to have a micro clearance with regard to the stator 300.

The shaft 210 may be disposed in an internal space provided by the upper housing 400 and the lower housing 500.

In addition, the shaft 210 may be inserted into the central hole of the fixed part 110 included in the hydrodynamic bearing assembly 100.

Next, rotational driving of the rotor 200 will be briefly described. When power is supplied to the stator coil 330 wound around the circumferential surface of the stator core 310, rotational driving force may be generated by electromagnetic interaction between the rotor core 210 and the stator core 310 around which the stator coil 330 is wound.

Therefore, the rotor core 220 rotates, such that the shaft 210 fixedly coupled to the rotor core 220 may be rotated.

The shaft 210 have the impeller 600 fixedly coupled to an upper end thereof, wherein the impeller 600 may be rotated together with the shaft 210.

The impeller housing 700 may be coupled to the upper housing 400 in a manner in which it encloses the impeller 600 and includes a through-hole (not shown) that may be in communication with external air.

Therefore, the external air may be drawn into the motor according to the embodiment of the present invention through the through-hole by rotation of the impeller 600.

The upper housing 400 may include the hydrodynamic bearing assembly 100 disposed on an inner peripheral surface thereof, and the lower housing 500 may be coupled to the upper housing 400 to provide an internal space.

FIG. 2 is a cross-sectional view showing a state in which the shaft and the hydrodynamic bearing assembly are coupled to each other in the motor according to the embodiment of the present invention; FIGS. 3A and 3B are enlarged cross-sectional views of part A of FIG. 2; and FIG. 4 is a cross-sectional view showing an oil storage part included in the hydrodynamic bearing assembly of the motor according to the embodiment of the present invention.

The hydrodynamic bearing assembly 100 included in the motor according to the embodiment of the present invention will be described with reference to FIGS. 2 through 4.

The fixed part 110 may have the central hole, and the shaft 210 may be rotatably inserted into the central hole of the fixed part 110 and be rotated together with the upper sealing part 120 and the lower sealing part 130.

That is, the fixed part 110 may rotatably support the shaft 210, the upper sealing part 120, and the lower sealing part 130.

More specifically, the shaft 210 may be inserted into the central hole of the fixed part 110 so as to have a micro clearance with regard to the fixed part 110, wherein the micro clearance may be provided with the lubricating fluid.

Meanwhile, the rotation of the shaft 210 may be more smoothly supported by fluid pressure generated by a radial dynamic pressure groove (not shown) formed in at least one of the outer peripheral surface of the shaft 210 and the inner peripheral surface of the fixed part 110.

At least one of the outer peripheral surface of the shaft 210 and the inner peripheral surface of the fixed part 110 may be provided with the radial dynamic pressure groove. The radial dynamic pressure groove may generate pressure so that the shaft 210 may be smoothly rotated in a state in which it is spaced apart from the fixed part 110 by a predetermined interval at the time of being rotated.

Here, the radial dynamic pressure groove may have any one of a herringbone pattern, a spiral pattern, and a helix pattern. However, the radial dynamic pressure groove may have any pattern as long as dynamic pressure may be generated. In addition, the number of radial dynamic pressure grooves is not limited.

The upper sealing part 120 may be coupled to an upper portion of the shaft 210 and be disposed to form a micro clearance with regard to an upper portion of the fixed part 110.

In addition, the lower sealing part 130 may be coupled to a lower portion of the shaft 210 and be disposed to form a micro clearance with regard to a lower portion of the fixed part 110.

Here, the upper portion and the lower portion of the fixed part 110 may be provided with a first groove part 111 and a second groove part 113 that are depressed inwardly, respectively, and end portions of the upper sealing part 120 and the lower sealing part 130 may be accommodated in the first groove part 111 and the second groove part 113, respectively.

The end portions of the upper sealing part 120 and the lower sealing part 130 may be accommodated in the first groove part 111 and the second groove part 113, respectively, to form a micro clearance with regard to an inner wall of the fixed part 110 forming the first groove part 111 and the second groove part 113, wherein the micro clearance may be provided with the lubricating fluid.

At least a portion of the inner wall of the fixed part 110 forming the first and second groove parts 111 and 113 may be tapered in order to seal the lubricating fluid, a first liquid-vapor interface I1 may be formed between the inner wall of the fixed part 110 forming the first groove part 111 and the upper sealing part 120, and a second liquid-vapor interface I2 may be formed between the lower sealing part 130 and the inner wall of the fixed part 110 forming the second groove part 113.

As shown in FIGS. 3A and 3B, a ‘U’ shaped micro clearance may be formed by an end portion of the upper sealing part 120 and the first groove part 111. Since the lubricating fluid is provided in the micro clearance and is sealed at the outermost portion of the micro clearance in the radial direction, a space in which the lubricating fluid is stored may be sufficiently secured.

An amount of the lubricating fluid may be gradually decreased due to factors such as leakage, evaporation, or the like, during driving of the motor. Therefore, sufficient fluid pressure may not be provided, having a serious effect on the driving of the motor.

However, in the motor according to the embodiment of the present invention, the first liquid-vapor interface I1 is formed between the upper sealing part 120 and the inner wall of the fixed part 110 forming the first groove part 111 and the second liquid-vapor interface I2 is formed between the lower sealing part 130 and the inner wall of the fixed part 110 forming the second groove part 113, whereby the space in which the lubricating fluid is stored may be sufficiently secured. As a result, a lifespan of the motor may be increased.

In addition, even in the case that the first liquid-vapor interface I1 or the second liquid-vapor interface I2 is moved in the inner radial direction due to evaporation of the lubricating fluid, the lubricating fluid may be continuously sealed between the first and second groove parts 111 and 113 and the fixed part 110.

Further, even in the case that the lubricating fluid is separated from an interface due to an external impact, or the like, to thereby be leaked, it may also be resealed by the taper structure formed on the inner wall of the fixed part 110 forming the first and second groove parts 111 and 113.

Meanwhile, at least one facing surface of the fixed part 110 and the upper and lower sealing parts 120 and 130 may be provided with a thrust dynamic pressure groove (not shown). The shaft 210 may be rotated together with the upper and lower sealing parts 120 and 130 in a state in which it secures predetermined floating force through the thrust dynamic pressure groove.

Here, the thrust dynamic pressure groove may have any one of a herringbone pattern, a spiral pattern, and a helix pattern, similar to the radial dynamic pressure groove. However, the thrust dynamic pressure groove may have any pattern as long as dynamic pressure may be generated thereby. In addition, the number of thrust dynamic pressure grooves is not limited.

A labyrinth sealing member 140 may be coupled to the lower portion of the fixed part 110 and may form a labyrinth seal between the labyrinth sealing member 140 and the lower sealing part 130.

The labyrinth sealing member 140 may be disposed to face an outer peripheral surface of the lower sealing part 130.

At least one facing surface of the labyrinth sealing member 140 and the lower sealing part 130 may be provided with a groove 141 to prevent external foreign objects from being introduced into the hydrodynamic bearing assembly 100 and prevent the lubricating fluid from being leaked.

That is, since a size of a clearance between the labyrinth sealing member 140 and the lower sealing part 130 is changed by the groove 141, a decrease in pressure and energy loss may be generated to prevent external foreign objects from being introduced into the hydrodynamic bearing assembly 100 and prevent the lubricating fluid from being leaked.

Meanwhile, referring to FIG. 4, the hydrodynamic bearing assembly 100 inclined in the motor according to the embodiment of the present invention may include an oil storage part 112.

The oil storage part 112 may be formed between an upper surface of the fixed part 110 and a lower surface of the upper sealing part 120.

More specifically, since a groove may be formed in at least one of the upper surface of the fixed part 110 and the lower surface of the upper sealing part 120 to expand a clearance between the upper surface of the fixed part 110 and the upper sealing part 120, the expanded clearance may serve as the oil storage part 112.

In addition, the oil storage part 112 may become wider in the outer radial direction.

Therefore, the space in which the lubricating fluid is stored may be increased by the oil storage part 112.

In the case of using the hydrodynamic bearing in a motor for a vacuum cleaner as described above, the generation of noise or vibrations at the time of high speed rotation may be suppressed, an effect of abrasion due to friction may be reduced, such that a lifespan of the motor may be increased, a lubricating fluid in the hydrodynamic bearing may perform a damping role when an external impact is applied to the motor, such that resistance to the external impact, or the like, may be enhanced, as compared with the case of using a ball bearing.

FIGS. 5A through 6B are cross-sectional views showing a bypass channel included in the hydrodynamic bearing assembly of the motor according to the embodiment of the present invention.

Referring to FIGS. 5A through 6B, the hydrodynamic bearing assembly of the motor according to the embodiment of the present invention may include at least one bypass channel 115, 117, 115′, and 117′.

The fixed part 110 may be provided with a first bypass channel 115 so that upper and lower surfaces of the fixed part 110 are in communication with each other and may be provided with a second bypass channel 117 so that the clearance between the fixed part 110 and the shaft 210 and the first bypass channel 115 are in communication with each other.

The first bypass channel 115 may be formed to allow the first and second groove parts 111 and 113 to be in communication with each other as shown in FIG. 5A, but is not limited thereto. That is, as shown in FIG. 6A, the first bypass channel 115′ may also be formed in an inner side of the first and second groove parts 111 and 113 in the radial direction.

The first and second bypass channels 115 and 117 may disperse pressure within the lubricating fluid to maintain balance within the pressure and move air bubbles, or the like, present in the lubricating fluid so as to be discharged by circulation.

FIG. 7 is a cross-sectional view showing a state in which the shaft, the hydrodynamic bearing assembly, the impeller, and a balancing unit are coupled to one another in the motor according to the embodiment of the present invention.

Referring to FIG. 7, the motor according to the embodiment of the present invention may include a balancing unit 150.

As shown in FIG. 7, the rotor core 220 may be fixedly coupled to the outer peripheral surface of the shaft 210, and an upper portion of the rotor core 220 on the outer peripheral surface of the shaft 210 may be provided with the hydrodynamic bearing assembly 100.

In other words, the rotor core 220 may be fixedly coupled to the lower portion of the shaft 210.

Here, the impeller 600, the balancing unit 150, the upper sealing part 120, the lower sealing part 130, the shaft 210, and the rotor core 220 may form a rotating member, and the fixed part 110 may be a fixed member.

In the case in which the balancing unit 150 is not included in the rotating member, the center of gravity of the rotating member is present in the lower portion of the shaft 210 due to the rotor core 220 which is relatively heavy.

Therefore, a problem that the shaft 210 is rotated in an eccentric manner in a state in which it is off-set from the center of an axis at the time of rotation of the rotating member may occur.

However, since the motor according to the embodiment of the present invention includes the balancing unit 150, the center of gravity of the rotating member may be positioned in the center of the axis by the balancing unit 150.

The balancing unit 150 may be coupled to the upper portion of the shaft 210 (above the fixed part 110). More specifically, the balancing unit 150 may be disposed between the impeller 600 and the hydrodynamic bearing assembly 100.

In addition, the balancing unit 150 may be spaced apart from the rotor core 220 by a predetermined interval.

A position and a mass of the balancing unit 150 may be appropriately determined in consideration of a position of the rotor core 220 and a mass of the rotating member including the rotor core 220.

Therefore, in the motor according to the embodiment of the present invention, the problem that the shaft 210 is rotated in a state in which it is eccentric from the center of the axis at the time of rotation of the rotating member may be prevented by the balancing unit 150.

That is, the balancing unit 150 may correct a rotational imbalance at the time of rotation of the rotating member including the shaft 210 and the rotor core 220.

Meanwhile, an outer peripheral surface of the balancing unit 150 may face one surface of the upper housing 400.

A groove 151 may be formed in the outer peripheral surface of the balancing unit 150 facing one surface of the upper housing 400 to prevent external foreign objects from being introduced into the hydrodynamic bearing assembly 100 and prevent the lubricating fluid from being leaked.

That is, since a size of a clearance between one surface of the upper housing 400 and the outer peripheral surface of the balancing unit 150 is changed by the groove 151, a decrease in pressure and energy loss may be generated to prevent external foreign objects from being introduced into the hydrodynamic bearing assembly 100 and prevent the lubricating fluid from being leaked.

FIG. 8 is a cross-sectional view showing a state in which a shaft and a hydrodynamic bearing assembly are coupled to each other in a motor according to another embodiment of the present invention.

Referring to FIG. 8, the motor according to this embodiment of the present invention may include a first liquid-vapor interface I1, a second liquid-vapor interface I2, a third liquid-vapor interface I3, and a fourth liquid-vapor interface I4.

A fixed part 110 may have a central hole, and a shaft 210 may be rotatably inserted into the central hole of the fixed part 110 and may be rotated together with an upper sealing part 120 and a lower sealing part 130.

That is, the fixed part 110 may rotatably support the shaft 210, the upper sealing part 120, and the lower sealing part 130.

More specifically, the shaft 210 may be inserted into the central hole of the fixed part 110 so as to have a micro clearance with regard to the fixed part 110, wherein the micro clearance may be provided with a lubricating fluid.

The upper sealing part 120 may be coupled to an upper portion of the shaft 210 and be disposed to form a micro clearance with regard to an upper portion of the fixed part 110.

In addition, the lower sealing part 130 may be coupled to a lower portion of the shaft 210 and be disposed to form a micro clearance with regard to a lower portion of the fixed part 110.

Here, the upper portion and the lower portion of the fixed part 110 may be provided with a first groove part 111 and a second groove part 113 that are depressed inwardly, respectively, and end portions of the upper sealing part 120 and the lower sealing part 130 may be accommodated in the first groove part 111 and the second groove part 113, respectively.

The end portions of the upper sealing part 120 and the lower sealing part 130 may be accommodated in the first groove part 111 and the second groove part 113, respectively, to form a micro clearance with an inner wall of the fixed part 110 forming the first groove part 111 and the second groove part 113, wherein the micro clearance may be provided with the lubricating fluid.

At least a portion of the inner wall of the fixed part 110 forming the first and second groove parts 111 and 113 may be tapered in order to seal the lubricating fluid, the first liquid-vapor interface I1 may be formed between the inner wall of the fixed part 110 forming the first groove part 111 and the upper sealing part 120, and the second liquid-vapor interface I2 may be formed between the lower sealing part 130 and the inner wall of the fixed part 110 forming the second groove part 113.

Meanwhile, the fixed part 110 may be provided with a separation groove 116 depressed from an inner peripheral surface of the fixed part 110 to separate the lubricating fluid provided in the clearance between the shaft 210 and the fixed part 110 into upper and lower portions in the axial direction.

The separation groove 116 may allow liquid-vapor interfaces to be formed with regard to an outer peripheral surface of the shaft 210 and the inner peripheral surface of the fixed part 110.

That is, the third liquid-vapor interface I3 may be formed upwardly of the separation groove 116 in the axial direction and the fourth liquid-vapor interface I4 may be formed downwardly of the separation groove 116 in the axial direction, based on the separation groove 116.

Here, in order to form the third and fourth liquid-vapor interfaces I3 and I4, the lubricating fluid provided between the outer peripheral surface of the shaft 210 and the inner peripheral surface of the fixed part 110 needs to contact air.

Therefore, the fixed part 110 may be provided with a communications part 119 allowing the separation groove 116 to be in communication with the outside, wherein the communications part 119 may be formed as a hole.

That is, the separation groove 116 and the outside of the fixed part 110 may have the same pressure due to the communications part 119.

Here, the communications part 119 may be formed horizontally in the radial direction as shown in FIG. 8, but is not limited thereto. That is, the communications part 119 may also be inclined upwardly or downwardly in the radial direction.

Meanwhile, at least one of the outer peripheral surface of the shaft 210 and the inner peripheral surface of the fixed part 110 may be provided with radial dynamic pressure grooves (not shown) in the upper and lower portions of the separation groove 116 based on the separation groove 116. The radial dynamic pressure grooves may generate pressure so that the shaft 210 may be smoothly rotated in a state in which it is spaced apart from the fixed part 110 by a predetermined interval at the time of being rotated.

Here, the radial dynamic pressure groove may have any one of a herringbone pattern, a spiral pattern, and a helix pattern. However, the radial dynamic pressure groove may have any pattern as long as dynamic pressure may be generated thereby. In addition, the number of radial dynamic pressure grooves is not limited.

In addition, at least one facing surface of the fixed part 110 and the upper and lower sealing parts 120 and 130 may be provided with a thrust dynamic pressure groove (not shown). The shaft 210 may be rotated together with the upper and lower sealing parts 120 and 130 in a state in which it secures predetermined floating force by the thrust dynamic pressure groove.

Here, the thrust dynamic pressure groove may have any one of a herringbone pattern, a spiral pattern, and a helix pattern, similar to the radial dynamic pressure groove. However, the thrust dynamic pressure groove may have any pattern as long as dynamic pressure may be generated. In addition, the number of thrust dynamic pressure grooves is not limited.

A labyrinth sealing member 140 may be coupled to the lower portion of the fixed part 110 and form a labyrinth seal between the labyrinth sealing member 140 and the lower sealing part 130.

The labyrinth sealing member 140 may be disposed to face an outer peripheral surface of the lower sealing part 130.

At least one facing surface of the labyrinth sealing member 140 and the lower sealing part 130 may be provided with a groove 141 to prevent external foreign objects from being introduced into the hydrodynamic bearing assembly 100 and prevent the lubricating fluid from being leaked.

That is, since a size of a clearance between the labyrinth sealing member 140 and the lower sealing part 130 is changed by the groove 141, a decrease in pressure and energy loss may be generated to prevent external foreign objects from being introduced into the hydrodynamic bearing assembly 100 and prevent the lubricating fluid from being leaked.

As set forth above, the hydrodynamic bearing assembly and the motor according to the embodiments of the present invention may have an increased lifespan, suppress generation of noise or vibration at the time of high speed rotation, and enhance resistance to external impacts, or the like.

In addition, the labyrinth seal is formed, whereby leakage of the lubricating fluid and introduction of external foreign objects may be prevented and rotational imbalance may be corrected at the time of rotation of the rotating member.

While the present invention has been shown and described in connection with the embodiments, it will be apparent to those skilled in the art that modifications and variations can be made without departing from the spirit and scope of the invention as defined by the appended claims.

What is claimed is:

1. A motor comprising:
an upper housing;
a lower housing coupled to the upper housing to provide an internal space;
a shaft disposed within the internal space and coupled to a hydrodynamic bearing assembly;
a rotor core coupled to the shaft and rotated together with the shaft; and
a balancing unit coupled to the shaft to correct a rotational imbalance at the time of rotation of the shaft and the rotor core.

2. The motor of claim 1, wherein the balancing unit is spaced apart from the rotor core by a predetermined interval.

3. The motor of claim 1, wherein the balancing unit includes a groove formed in an outer peripheral surface thereof.

4. The motor of claim 1, further comprising:
a stator coupled to the lower housing and disposed to have a micro clearance with regard to the rotor core;
an impeller fixed to an upper portion of the shaft; and
an impeller housing coupled to the upper housing.

5. The motor of claim 1, wherein the hydrodynamic bearing assembly includes:
a fixed part having a central hole into which the shaft is inserted and rotatably supporting the shaft;
an upper sealing part coupled to an upper portion of the shaft and disposed to form a micro clearance with regard to an upper portion of the fixed part; and
a lower sealing part coupled to a lower portion of the shaft and disposed to form a micro clearance with regard to a lower portion of the fixed part.

6. The motor of claim 5, further comprising a labyrinth sealing member coupled to the lower portion of the fixed part to form a labyrinth seal between the labyrinth sealing member and the lower sealing member.

7. The motor of claim 5, wherein at least one facing surface of the lower sealing part and the labyrinth sealing member is provided with a groove.

8. The motor of claim 5, wherein the balancing unit is disposed above the fixed part, and
the rotor core is disposed below the fixed part.

9. The motor of claim 5, wherein the upper and lower portions of the fixed part are provided with first and second groove parts depressed inwardly, respectively, and
end portions of the upper sealing part and the lower sealing part are accommodated in the first and second groove parts, respectively.

10. The motor of claim 9, wherein at least a portion of an inner wall of the fixed part forming the first and second groove parts is tapered.

11. The motor of claim 9, wherein the upper sealing part and the first groove part have a first liquid-vapor interface formed therebetween, and
the lower sealing part and the second groove part have a second liquid-vapor interface formed therebetween.

12. The motor of claim 5, wherein the fixed part is provided with a first bypass channel so that upper and lower surfaces of the fixed part are in communication with each other.

13. The motor of claim 12, wherein the fixed part is provided with a second bypass channel so that a clearance between the shaft and the fixed part and the first bypass channel are in communication with each other.

14. A motor comprising:
an upper housing;
a lower housing coupled to the upper housing to provide an internal space;
a shaft disposed within the internal space and coupled to a hydrodynamic bearing assembly;
a rotor core coupled to the shaft and rotated together with the shaft; and
a balancing unit coupled to the shaft to correct a rotational imbalance at the time of rotation of the shaft and the rotor core,
wherein the hydrodynamic bearing assembly includes:
a fixed part having a central hole into which the shaft is inserted and rotatably supporting the shaft;
an upper sealing part coupled to an upper portion of the shaft and disposed to form a micro clearance with regard to an upper portion of the fixed part; and
a lower sealing part coupled to a lower portion of the shaft and disposed to form a micro clearance with regard to a lower portion of the fixed part,
the fixed part being provided with a separation groove depressed from an inner peripheral surface of the fixed part to separate a lubricating fluid provided in a clearance between the shaft and the fixed part into upper and lower portions in an axial direction and being provided with a communications part allowing the separation groove to be in communication with the outside.

15. The motor of claim 14, further comprising:
a stator coupled to the lower housing and disposed to have a micro clearance with regard to the rotor core;
an impeller fixed to the upper portion of the shaft; and
an impeller housing coupled to the upper housing.

16. The motor of claim 14, wherein the upper sealing part and the fixed part have a first liquid-vapor interface formed therebetween, and
the lower sealing part and the fixed part have a second liquid-vapor interface formed therebetween.

17. The motor of claim 14, wherein the separation groove has a third liquid-vapor interface formed in an upper portion thereof in the axial direction and a fourth liquid-vapor interface formed in a lower portion thereof in the axial direction.
